(19) United States
(12) Patent Application Publication
(10) Pub. No.: US 2025/0037090 A1
(43) Pub. Date: Jan. 30, 2025

(54) SYSTEM AND METHOD FOR AUTOMATED SERVICE STATUS AND IMPAIRMENT TRACKING

(71) Applicant: Aztek Securities, LLC, Baton Rouge, LA (US)

(72) Inventors: Nitin Kamath, Baton Rouge, LA (US); Aparna Kamath, Baton Rouge, LA (US); Sachin Kamath, Prairieville, LA (US)

(21) Appl. No.: 18/416,000

(22) Filed: Jan. 18, 2024

Related U.S. Application Data
(63) Continuation of application No. 18/374,619, filed on Sep. 28, 2023.
(60) Provisional application No. 63/529,390, filed on Jul. 28, 2023.

(51) Int. Cl. G06Q 10/20; G06Q 10/0631; G06Q 10/087; H04L 9/40

(52) U.S. Cl. CPC G06Q 10/20; G06Q 10/063112; G06Q 10/06315; G06Q 10/087; H04L 63/083

(57) ABSTRACT

A system and method for automated service status and impairment tracking incorporating one or more system and methods for providing real-time credential checking, geo-fenced inspections, automated impairment tracking and reporting, prognostic inventory, smart modifiable forms, parts and labor tracking and integrated billing and fee collection, or any combination thereof

### RELATED APPLICATIONS

This application is a continuation of U.S. patent application Ser. No. 18/374,619, filed Sep. 28, 2023, which claims the benefit of U.S. Provisional Patent Application No. 63/529,390, filed Jul. 28, 2023, all of which are hereby incorporated by reference in their entireties.

### TECHNICAL FIELD

The present disclosure is directed to an automated system and method for providing automatic service status tracking of equipment of which need to have its service status certified on a regular or semi-regular basis, such as fire extinguishers, sprinkler systems and elevators, etc. Embodiments of the present invention generate and ensure automated service status and impairment tracking of such equipment, with certain embodiments of the invention incorporating one or more system and methods for providing real-time credential checking, geo-fenced inspections, automated impairment tracking and reporting, prognostic inventory, smart modifiable forms, parts and labor tracking and integrated billing and fee collection, or any combination thereof.

### BACKGROUND

There exists numerous types of equipment that requires routine maintenance and certification on a regular or semi-regular basis. This includes all types of equipment, such as fire extinguishers, sprinkler systems and elevators, alarm systems, emergency exit equipment and signage, and many other types of critical and non-critical equipment and infrastructure.

On top of needing routine maintenance and certification, typically there is a listing of impairments to go along with the equipment. If there are no issues, the equipment may be certified. If there is an impairment, typically it is identified by severity, such as minor impairment or major impairment. It is also possible that the equipment has not been serviced recently, so any inspection is inherently expired.

In many instances, impairments are typically just tracked by placing a sticker or something similar on the equipment itself. This can be less than ideal, as stickers can wear, fade, be peeled off, or otherwise be removed or disappear from the equipment, leaving it unknown as to what the impairment status of a particular equipment is.

Additionally, even when a piece of equipment is serviced, there are currently no systems or methods to confirm whether a service personnel is actually licensed or in good standing to perform a specific service. This means that a piece of equipment could end up being certified, without actually having the service completed on the equipment, or at least completed correctly.

Finally, there are also no ways currently to confirm whether a service personnel actually even went to the location of the equipment to perform the service, or have the correct parts required to complete a service or repair.

Therefore, there is a need in the art for a system and method for automated service status and impairment tracking incorporating one or more system and methods for providing real-time credential checking, geo-fenced inspections, automated impairment tracking and reporting, prognostic inventory, smart modifiable forms, parts and labor tracking and integrated billing and fee collection, or any combination thereof.

### SUMMARY OF THE INVENTION

According to an embodiment of the present invention, a system for automated service status and impairment tracking comprises: one or more hardware processors configured by machine readable instructions to: receive a request to initiate a service update on a unit of equipment; identify said unit of equipment via an identifier provided by an input means, wherein said identifier is associated with said unit of equipment; identify a service personnel to conduct said service update; receive service confirmation from said service personnel; verify, via a credential confirmation module, credentials of said service personnel; verify, via one or more location-based service modules, said service personnel was in a specified vicinity of said unit of equipment; and update an impairment status of service associated with said unit of equipment, based at least in part on said credentials of said service personnel and said service personnel being verified in the specified vicinity of said unit of equipment. And the ability for the Authority Having Jurisdiction (AHJ) to view the real-time status of such equipment.

In certain embodiments of the present invention, the one or more hardware processors are further configured by machine readable instructions to: verify a type of service to be performed on said unit of equipment; verify one or more parts required to complete the type of service to be performed on said unit of equipment; and verify that said one or more parts required to complete the type of service to be performed on said unit of equipment are in possession by the service personnel.

In certain embodiments of the present invention, the one or more hardware processors are further configured by machine readable instructions to: remove the said one or more parts required to complete the type of service to be performed on said unit of equipment from an inventory of parts associated with said service personnel.

In certain embodiments of the present invention, the one or more parts required to complete the service to be performed on said unit of equipment is completed via the one or more hardware processors analyzing data provided by the service personnel.

In certain embodiments of the present invention, the data provided by the service personnel is one or more images of said one or more parts required to complete the services to be performed on said unit of equipment.

In certain embodiments of the present invention, the analysis of the images of said one or more parts required to complete the services to be performed on said unit of equipment is performed via image analysis using a machine learning module trained on image data of said one or more parts.

In certain embodiments of the present invention, the service personnel has access to step-by-step “How To” video for the specific type of equipment for inspection and service. by make, model, class?

In certain embodiments of the present invention, the one or more hardware processors are further configured by machine readable instructions to: receive data associated with said impairment status of said unit of equipment; and generate an additional service update on said unit of equipment, based at least in part on said data associated with said impairment status of said unit of equipment.

In certain embodiments of the present invention, the one or more hardware processors is further configured by machine readable instructions to receive status information from said unit of equipment.

In certain embodiments of the present invention, the one or more hardware processors is further configured by machine readable instructions to provide the status information from said unit of equipment to said service personnel.

In certain embodiments of the present invention, the status information from said unit of equipment is related to the impairment status of said unit of equipment.

In certain embodiments of the present invention, the AHJ is being notified on the system status.

In certain embodiments of the present invention, the system can trigger an automated regulatory notification to the equipment owner, based on AHJ statutes/regulation.

In certain embodiments of the present invention, the system presents AHJ with visual and spatial tools for assessing the equipment status in their jurisdiction.

In certain embodiments of the present invention, the system presents Property Owner/POR with visual and spatial tools for assessing the equipment status on their properties.

According to an embodiment of the present invention, a method for automated service status and impairment tracking comprises: receiving, via a communications module, a request to initiate a service update on a unit of equipment; identifying, via one or more processors, said unit of equipment via an identifier provided by an input means, wherein said identifier is associated with said unit of equipment; identifying, via said one or more processors, a service personnel to conduct said service update; receiving, via said one or more processors, service confirmation from said service personnel; verifying, via a credential confirmation module, credentials of said service personnel; verifying, via one or more location-based service modules, said service personnel was in a specified vicinity of said unit of equipment; and updating, via said one or more processors, an impairment status of service associated with said unit of equipment, based at least in part on said credentials of said service personnel and said service personnel being verified in the specified vicinity of said unit of equipment.

In certain embodiments of the present invention, the method further comprises: verifying, via said one or more processors, a type of service to be performed on said unit of equipment; verifying, via said one or more processors, one or more parts required to complete the type of service to be performed on said unit of equipment; and verifying, via said one or more processors, that said one or more parts required to complete the type of service to be performed on said unit of equipment are in possession by the service personnel.

In certain embodiments of the present invention, the method further comprises: removing, via said one or more processors, the said one or more parts required to complete the type of service to be performed on said unit of equipment from an inventory of parts associated with said service personnel.

In certain embodiments of the present invention, the method further comprises: verifying that said one or more parts required to complete the service to be performed on said unit of equipment is completed via the one or more processors analyzing data provided by the service personnel.

In certain embodiments of the present invention, the method further comprises: receiving, via said one or more processors, data associated with said impairment status of said unit of equipment; and generating, via said one or more processors, an additional service update on said unit of equipment, based at least in part on said data associated with said impairment status of said unit of equipment.

In certain embodiments of the present invention, the method further comprises: receiving, via said one or more processors, status information from said unit of equipment.

In certain embodiments of the present invention, the method further comprises: providing, via said one or more processors, the status information from said unit of equipment to said service personnel.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a schematic illustration of an exemplary computing device, in accordance with at least some exemplary embodiments of the present invention;

FIG. 2 is a schematic illustration of an exemplary network, in accordance with at least some exemplary embodiments of the present invention;

FIG. 3 is an illustration of an exemplary method for providing automated service status and impairment tracking, in accordance with an embodiment of the present invention;

FIG. 4 is an illustration of an exemplary method for providing automated service status and impairment tracking, in accordance with an embodiment of the present invention; and

FIG. 5-8 are illustrations of an information related to an exemplary method for providing automated service status and impairment tracking, in accordance with an embodiment of the present invention.

### DETAILED DESCRIPTION

According to one embodiment of the present invention, a system for automated service status and impairment tracking may be comprised of a set of computer enabled modules that provide entities (which include but are not limited to regulatory and contractors) the ability to track the serviceable status of a given unit of equipment. The serviceable status of the unit may be provided by the system. In certain embodiments, the system can determine serviceable status of a unit in a customizable, and frequency based manner, involving pertinent inspections that may either pass without any impairments or fail with one or more impairments.

In certain embodiments of the present invention, a unique and customizable inspection questionnaire methodology may be implemented in the system. The unique and customizable inspection questionnaire helps to standardize an inspection process. In certain embodiments, the system may mandates that all questions, or a certain subset of all the questions, are answered, ensuring the serviceable status of the unit.

According to an embodiment of the present invention, the system may digitally collect and store data associated with a unit inspection, creating a history which allows users to track and analyze inspections that occur throughout the serviceable life cycle of a given unit. In certain embodiments, the system may also digitally collect and store elements of a unit. Element information is helpful with unit maintenance or repairs to fix an impairment. In certain embodiments, the latest serviceable status of a unit can be viewed by any public or regulatory entity on a computing device, such as a smartphone with a camera, internet access, and web browser. In certain embodiments, this is made possible by the system through use of a unique digital code displayed on a specific unit. For instance, the unique digital code may be displayed on the unit by way of a physical tag that is attached to a unit during inspection to identify the specific unit, or otherwise may be provided electronically via a form of electronic “tag”, such as via RFID tag, Bluetooth enabled tag, WIFI tag, or other IoT tag that is configured to provide the unique digital code to a user's device.

According to one embodiment of the present invention, the system may utilize a simple and easy to understand color code system to quickly identify any given unit status. The ADA compliant color code system starts with Green for Certified and Active, followed by Yellow for Minor impairments, Amber for Expired tags, Blue for Repaired, and Red, with white, for Major impairments.

In certain embodiments of the present invention, the system may also be configured to collect and store location information related to the unit, such as GPS coordinates, latitude and longitude information, pin location dropped on an electronically stored map, or other form of location information. The system may utilize location-based services (LBS) and/or geo-fencing technology for inspection fraud control. In other words, the system may be configured to ensure an individual performing an inspection of the unit is within a configurable vicinity/radius of the unit during a specific time or other indicator that the service personnel is in the vicinity/radius. For instance, in certain embodiments, the system may be configured to use collected GPS coordinates of units to help entities get a quick visual display of all units and their serviceable status within a geographical area with the use of a spatial mapping service, and identify and deploy inspection personnel to units in need of service.

In certain embodiments, the system may be configured to use the collected GPS coordinates of units to help service personnel map an optimized route for the daily set service requirements.

In other embodiments, other forms of LBS or geo-fencing technologies may be used, such as cellular/radio triangulation, network location detection (e.g., joining a WIFI local to the equipment), swipe card, biometric scanning, image analysis (e.g., service personnel needs to take a physical photo of the equipment, or an identifier associated with the equipment (e.g., QR Code, serial number, physical location that can be identified by a machine learning system trained on data associated with the location), which can be verified via an image analysis system).

The system may be further configured to note and display impairments on units. For instance, a display unit may be incorporated onto the equipment, which would display the impairment status of the equipment. In other embodiments, a QR code or other identifier could be affixed to the equipment, which could be scanned by an individual and that would take the individual (via a mobile device or other computing device) to a URL that would display the equipment's impairment status. One of ordinary skill in the art would appreciate that there are numerous methods for note and/or display impairments on equipment, and embodiments of the present invention are contemplated for use with any such methods.

In accordance with one embodiment of the present invention, the system may be configured with modules able to provide analysis of the digitally collected inspection data alerts using artificial intelligence or machine learning means, including, but not limited to, machine learning models trained on various amounts of test and training data, neural networks (e.g., Artificial Neural Networks (ANN), Convolution Neural Networks (CNN), Recurrent Neural Networks (RNN)), deep learning models and deep-learning-based generative models (e.g., generative adversarial networks (GANs)). One of ordinary skill in the art would appreciate that there are numerous types of ML and AI systems that could be used for the purposes detailed herein, and embodiments of the present invention are contemplated for use with any such ML or AI system as contractor entities of impaired units that need service action. This also helps regulatory entities to document and enforce the applicable laws. The analysis also delivers notifications regarding preventive measures to the responsible entities (owners/operators) for maintaining the serviceability of the unit.

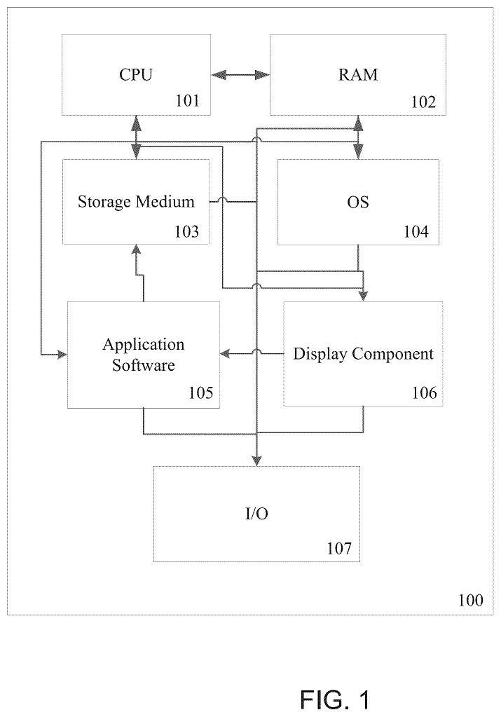

Turning now to FIG. 1, an illustrative representation of a computing device appropriate for use with embodiments of the system of the present disclosure is shown. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element (e.g., monitor, capacitive touchscreen) 106, and one or more input/output devices/means 107, including one or more communication interfaces (e.g., RS232, Ethernet, Wifi, Bluetooth, USB). Useful examples include, but are not limited to, personal computers, servers, tablet PCs, smartphones, or other computing devices. In preferred embodiments of the present invention, multiple computing devices can be operably linked to form a computer network in a manner as to distribute and share one or more resources, such as clustered computing devices and server banks/farms.

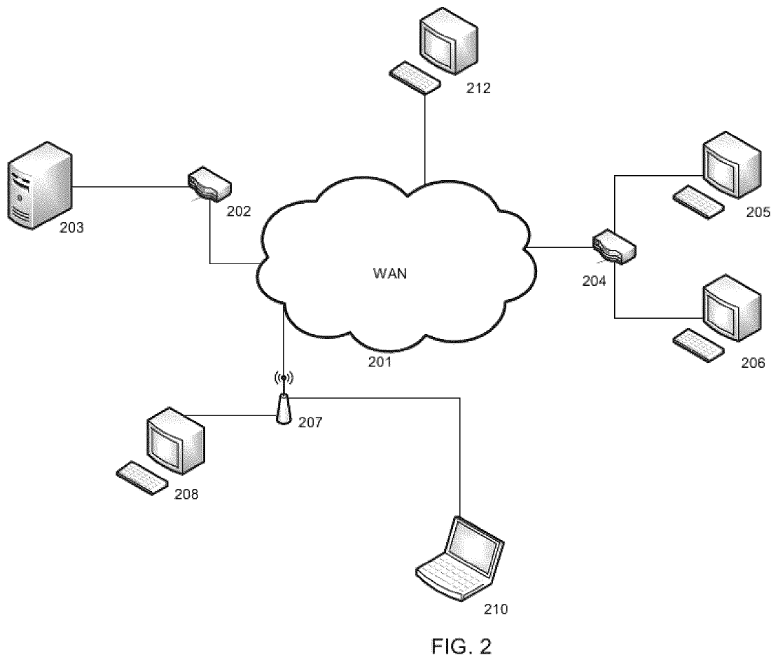

Various examples of such single-unit and multi-unit computer networks suitable for embodiments of the disclosure, their typical configuration and many standardized communication links are well known to one skilled in the art, as explained in more detail and illustrated by FIG. 2, which is discussed herein-below.

According to an exemplary embodiment of the present disclosure, data may be transferred to the system, stored by the system and/or transferred by the system to users of the system across local area networks (LANs) or wide area networks (WANs). In accordance with the previous embodiment, the system may be comprised of numerous servers, mining hardware, computing devices, or any combination thereof, communicatively connected across one or more LANs and/or WANs. One of ordinary skill in the art would appreciate that there are numerous manners in which the system could be configured and embodiments of the present disclosure are contemplated for use with any configuration.

Referring to FIG. 2, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, or iii) through a computing device 208, 210 connected to a wireless access point 207. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The exemplary disclosed system and method may be used in any suitable application for providing a method for automated service status and impairment tracking. The exemplary disclosed system and method may for example be used in any application in which providing automated service status and impairment tracking is useful in ensuring the tracking of maintenance and impairments on a unit of equipment over its lifespan.

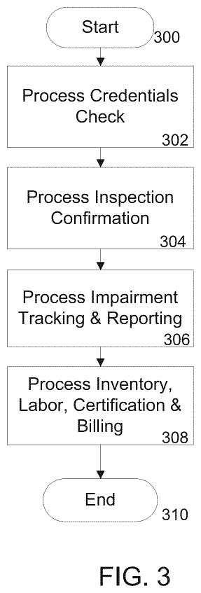

Turning now to FIG. 3, an exemplary method for providing automated service status and impairment tracking, in accordance with an embodiment of the present invention, is shown. The process starts at 300 with the system being engaged to initiate a service update on a unit of equipment. The system may be configured to identify or receive from a unit, the need for a unit to be serviced. For instance, in certain embodiments, the system may have a maintenance schedule for units, and as the date for service approaches, the system may automatically schedule maintenance. In other embodiments, the unit may be equipped with means for notifying the system of the need for service, whether by passage of time, or by an event that would note the need for service (e.g., tripping a sensor notifying that that unit is out of specification for one or more criteria). One of ordinary skill in the art would appreciate that there are numerous ways that a system could be configured to be alerted or engaged to begin the maintenance process. At step 302, the system will identify personnel to conduct the maintenance. Either prior to, or when personnel arrives in the vicinity of the unit, the system can confirm the credentials of the personnel, to ensure that they are qualified to perform the maintenance on the unit.

At step 304, the system receives information related to the inspection by the personnel. The system may be configured to ensure that the inspection was properly conducted and verify the personnel was actually able to conduct the service. This may include verifying the personnel were in the vicinity of the unit at the time of the service (e.g., via geo-fencing or other location verification means).

It may also include a standard questionnaire based on equipment type, inspection frequency and inspection type.

It may also include verification that repair or maintenance parts were available and/or used on the service. For instance, the system may require repair personnel to scan, take pictures of, or otherwise confirm that the appropriate repair or maintenance parts were actually in their possession and/or were actually utilized. In certain embodiments, the system may use image analysis powered by AI or ML systems to confirm submissions by repair personnel. One of ordinary skill in the art would appreciate that there are numerous methods for confirming inspection and/or use of repair/maintenance parts, and embodiments of the present invention are contemplated for use with any appropriate methods/means.

At step 306, the system processes any impairment related to the unit. In certain cases, repair/maintenance personnel will not be able to correct or validate the status of a unit, such that it would be free of impairments. In this case, the system provides a means for the personnel to input impairment information related to the unit. This may also include the ability for the personnel to scan or otherwise identify certain components or aspects of the unit that are impaired, allowing the system to track the need for additional repair, or parts, in order to correct the impairment. In certain embodiments, the system may also be configured to schedule future repair of the impairment by the same or additional personnel. At step 308, the system may be configured to process and update the inventory of any maintenance and/or repair parts used on the unit, finally confirm the status of the unit, the certification of the personnel and that the personnel actually conducted the maintenance and/or repair, and issue a bill to the relevant party for the maintenance and/or repair. At this point, the process terminates at step 310.

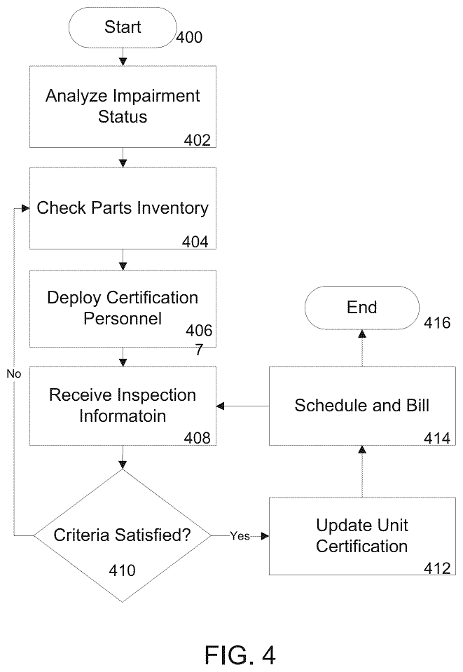

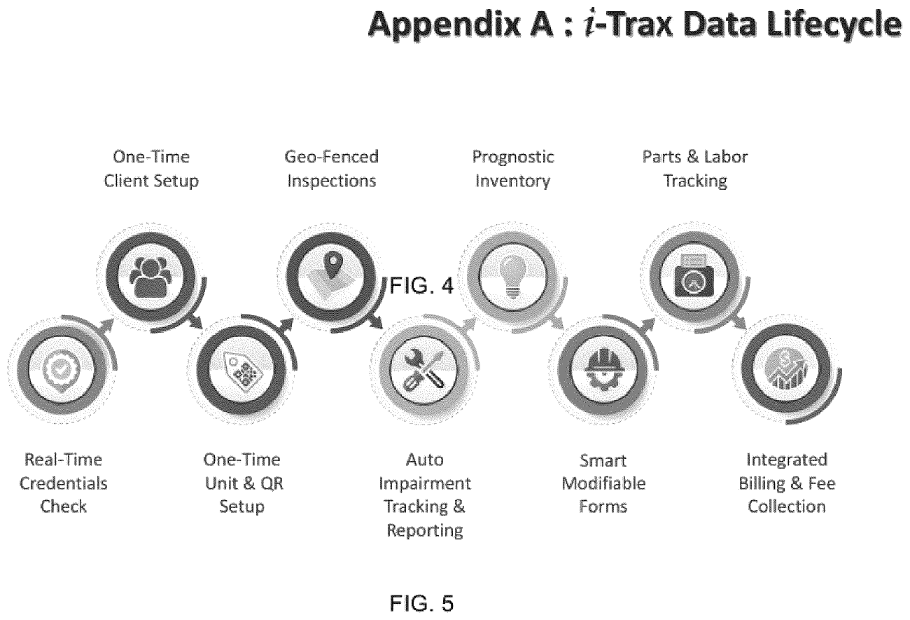

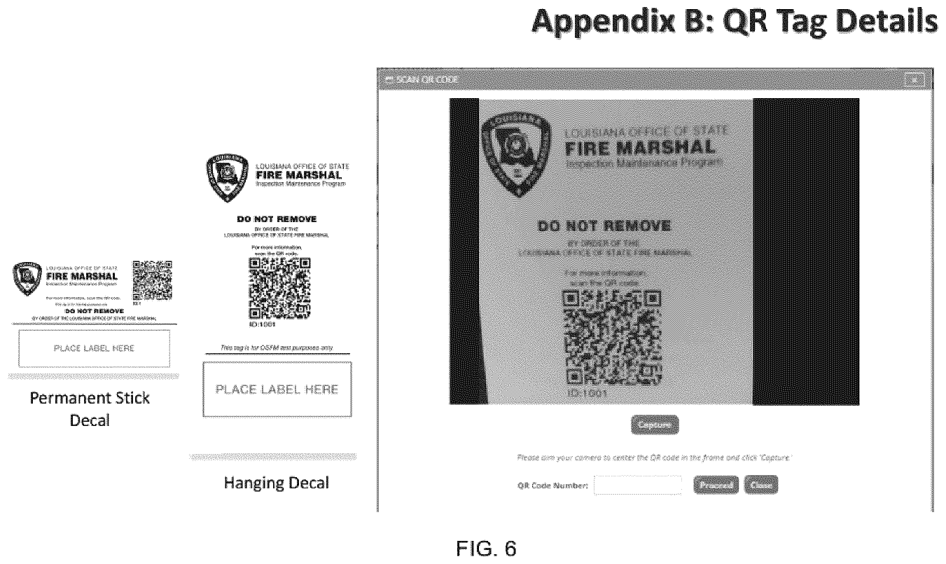

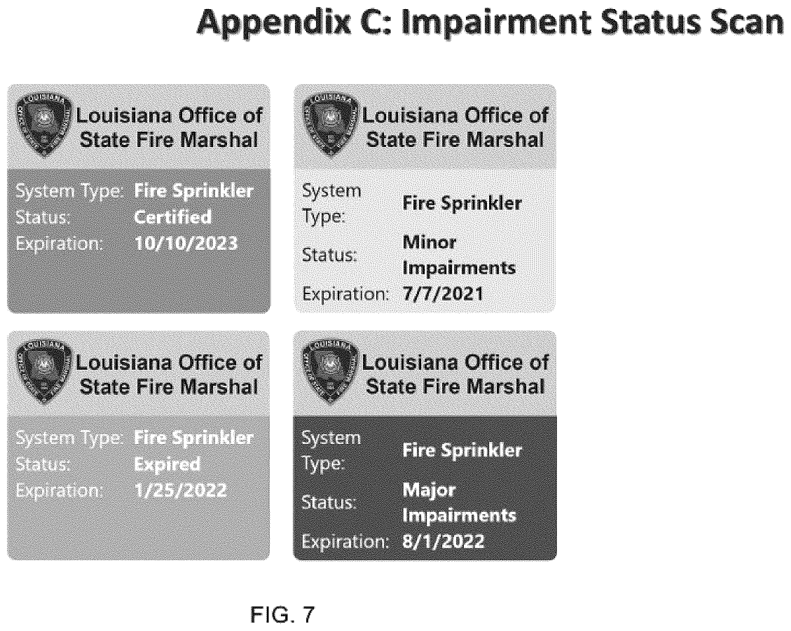

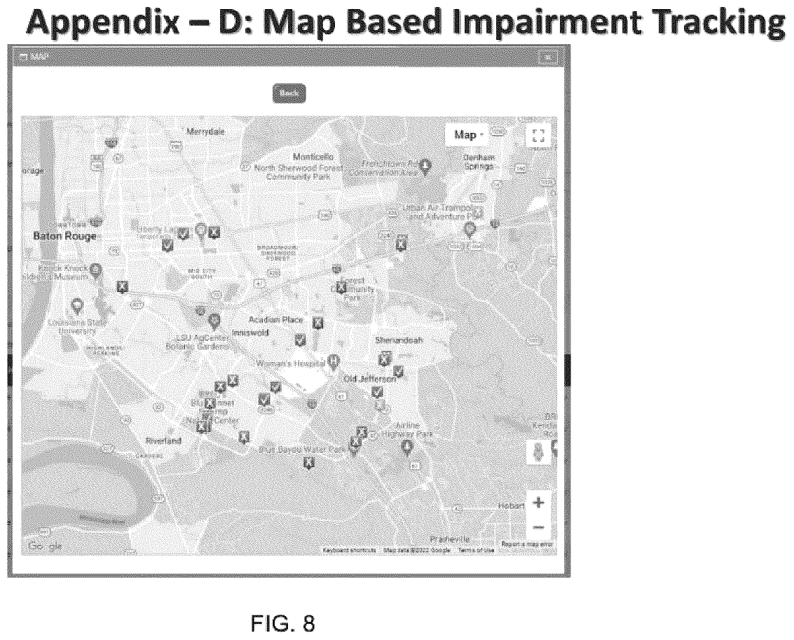

Turning now to FIG. 4, an illustration of an exemplary method for providing automated service status and impairment tracking, in accordance with an embodiment of the present invention, is shown. The process starts at step 400 with the system being engaged to analyze the status of a unit and automate the process for resolving any impairments for the unit. At step 402, the system analyzes the impairment status of a unit. In certain embodiments, the system may be configured to receive updates from the unit itself, where the unit is equipped with components capable of reporting impairment status, such as via IoT equipment, such as sensors and communications means. In other embodiments, the system may engage its analysis based on information reported to it by repair or maintenance personnel, or via information previously stored in the system.

At step 404, the system identifies that resolution of the impairment requires certain parts or other service equipment in order to resolve the impairment. The system then checks available inventory for such equipment or parts. If the parts are in inventory, or otherwise accessible to repair or maintenance personnel, the system may move to step 406. If the parts are not in inventory, the system may be engaged to source the parts through a variety of means, whether via automated parts ordering, or via sending notifications to operations or repair and maintenance personnel.

At step 406, the system has identified that parts are available, and deploys the necessary repair or maintenance personnel to correct the impairment. At step 408, the repair or maintenance personnel have claimed to have completed the inspection and repair of any impairment. The system receives information from the personnel related to the inspection and/or repair. At step 410, based on the service personnel input the system confirms whether impairment repair criteria have been met. If the criteria have not been met, the system kicks the process back to step 402 and repeats the repair/maintenance process. If the system confirms the impairment was alleviated and maintenance completed, the process moves to step 412 and updates the certification of the unit. At step 414, the system will process the work completed by the personnel and generate a bill related to the work. At step 416, the system will update the next scheduling of repair/maintenance and the process will terminate.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on-any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

1. A system for automated service status and impairment tracking, the system comprising:
a network;
a database in communication with the network;
a provider device in communication with the network; and
a user device in communication with the network, the user device being associated with a respective service personnel of one or more service personnel;
wherein the database is configured by machine readable instructions to:
store information about one or more units of equipment, the information about each of the one or more units of equipment comprising:
a Global Positioning System (GPS) coordinate of the unit of equipment; and
an impairment status of the unit of equipment;
store information about the one or more service personnel, the information about each of the one or more service personnel comprising:
a GPS coordinate of the service personnel;
a credentials of the service personnel;
transmit the stored information about one or more units of equipment and the stored information about one or more service personnel to at least one of the provider device and the user device;
wherein the provider device has one or more hardware processors configured by machine readable instructions to:
receive a request to initiate a service update on a unit of equipment of the one or more units of equipment;
identify a service personnel from the one or more service personnel to conduct the service update based at least in part on the credentials of the service personnel and the GPS coordinate of the service personnel stored on the database;
determine an optimized service route of the service personnel based at least in part on the GPS coordinate of the unit of equipment and the GPS coordinate of the service personnel;
transmit the optimized service route to the user device; and
update an impairment status of service associated with the unit of equipment and store the update on the database;
wherein the user device has one or more hardware processors configured by machine readable instructions to:
verify, via a credential confirmation software module, the credentials of the service personnel;
display the optimized service route on the user device to the service personnel;
identify the unit of equipment via an identifier provided by an input means, wherein the identifier is associated with the unit of equipment;
track the GPS coordinate of the service personnel, via one or more location-based service software modules;
verify, via one or more location-based service software modules, the service personnel was in a specified vicinity of the GPS coordinates of the identified unit of equipment; and
transmit service confirmation, the credentials of the service personnel, and the service personnel being verified in the specified vicinity of the unit of equipment to the provider device;
wherein the update to the impairment status of the unit of equipment is based at least in part on the credentials of the service personnel and the service personnel being verified in the specified vicinity of the unit of equipment.

2. The system of claim 1, wherein said one or more hardware processors of the user device are further configured by machine readable instructions to:
verify a type of service to be performed on said unit of equipment;
verify one or more parts required to complete the type of service to be performed on said unit of equipment; and
verify that said one or more parts required to complete the type of service to be performed on said unit of equipment are in possession by the service personnel.

3. The system of claim 2, wherein said one or more hardware processors of the user device are further configured by machine readable instructions to:
remove the said one or more parts required to complete the type of service to be performed on said unit of equipment from an inventory of parts associated with said service personnel.

4. The system of claim 2, wherein verifying that said one or more parts required to complete the service to be performed on said unit of equipment is completed via the one or more hardware processors analyzing data provided by the user device.

5. The system of claim 4, wherein the data provided by the user device is one or more images of said one or more parts required to complete the services to be performed on said unit of equipment.

6. The system of claim 5, wherein analysis of the images of said one or more parts required to complete the services to be performed on said unit of equipment is performed via image analysis and how to videos using a machine learning software module trained on image data of said one or more parts.

7. The system of claim 1, wherein said one or more hardware processors of the user device are further configured by machine readable instructions to:
receive data associated with said impairment status of said unit of equipment; and
generate an additional service update on said unit of equipment, based at least in part on said data associated with said impairment status of said unit of equipment.

8. The system of claim 1, wherein the one or more hardware processors of the user device is further configured by machine readable instructions to;
receive status information from said unit of equipment; and
transmit the status information about said unit of equipment to the database for storage.

9. The system of claim 8, wherein the one or more hardware processors of the provider device are is further configured by machine readable instructions to;
retrieve the status information about said unit of equipment from the database; and
transmit the status information about said unit of equipment to an Authority Having Jurisdiction (AHJ) and a property owner.

10. The system of claim 9, wherein the status information from said unit of equipment is related to the impairment status of said unit of equipment.

11. A method for automated service status and impairment tracking, the method comprising:
storing information about one or more units of equipment on a database, the information about each of the one or more units of equipment comprising:
a Global Positioning System (GPS) coordinate of the unit of equipment; and
an impairment status of the unit of equipment;
storing information about one or more service personnel on the database, the information about each of the one or more service personnel comprising:
a GPS coordinate of the service personnel;
a credentials of the service personnel;
transmitting the stored information about one or more units of equipment and the stored information about one or more service personnel to at least one of a provider device and a user device;
receiving a request to initiate a service update on a unit of equipment of the one or more units of equipment on the provider device;
identifying a service personnel, via the provider device, from the one or more service personnel to conduct the service update based at least in part on the credentials of the service personnel and the GPS coordinate of the service personnel stored on the database;
verifying, via a credential confirmation software module on the user device, the credentials of the service personnel;
determining an optimized service route, via the provider device, of the service personnel based at least in part on the GPS coordinate of the unit of equipment and the GPS coordinate of the service personnel;
transmitting the optimized service route to the user device;
displaying the optimized service route on the user device to the service personnel;
identify the unit of equipment via an identifier provided by an input means on the user device, wherein the identifier is associated with the unit of equipment;
tracking the GPS coordinate of the service personnel, via one or more location-based service software modules on the user device;
verifying, via one or more location-based service software modules on the user device, the service personnel was in a specified vicinity of the GPS coordinates of the identified unit of equipment;
transmitting the service confirmation, the credentials of the service personnel, and the service personnel being verified in the specified vicinity of the unit of equipment to the provider device;
updating an impairment status of service associated with the unit of equipment, via the provider device and storing the update on the database;
wherein the update to the impairment status of the unit of equipment is based at least in part on the credentials of the service personnel and the service personnel being verified in the specified vicinity of the unit of equipment.

12. The method of claim 11, further comprising:
verifying, via the user device, a type of service to be performed on said unit of equipment;
verifying, via the user device, one or more parts required to complete the type of service to be performed on said unit of equipment;
verifying, via the user device, that said one or more parts required to complete the type of service to be performed on said unit of equipment are in possession by the service personnel; and
removing, via the user device, the said one or more parts required to complete the type of service to be performed on said unit of equipment from an inventory of parts associated with said service personnel.

13. (canceled)

14. The method of claim 12, wherein verifying that said one or more parts required to complete the service to be performed on said unit of equipment is completed via the user device analyzing data provided by the service personnel.

15. The method of claim 14, wherein the data provided by the user device is one or more images of said one or more parts required to complete the services to be performed on said unit of equipment.

16. The method of claim 15, wherein analysis of the images of said one or more parts required to complete the services to be performed on said unit of equipment is performed via image analysis and how to videos using a machine learning software module trained on image data of said one or more parts.

17. The method of claim 11, further comprising:
receiving, via the user device, data associated with said impairment status of said unit of equipment; and
generating, via said one or more processors, an additional service update on said unit of equipment, based at least in part on said data associated with said impairment status of said unit of equipment.

18. The method of claim 11, further comprising:
receiving, via the user device, status information from said unit of equipment;
transmitting, via the user device, the status information about said user of equipment to the database;
retrieving, via the provider device, the status information about said unit of equipment from the database; and
transmitting, via the provider device, the status information from said unit of equipment to an Authority Having Jurisdiction (AHJ) and a property owner.

19. (canceled)

20. (canceled)

21. The system of claim 1, further comprising a third party device in communication with the network;
wherein the third party device receives updates to the impairment status of the unit of equipment in real time.

22. The system of claim 21, wherein the one or more hardware processors of the provider device are further configured by machine readable instructions to:
generate a bill based at least in part on the request to initiate the service update on the unit of equipment and the update to the impairment status of the unit of equipment; and
transmitting the generated bill to the third party device.

23. The system of claim 1, wherein the one or more hardware processors of the user device are further configured by machine readable instructions to:
track a time the service personnel was in the specified vicinity of the unit of equipment;
transmit the time the service personnel was in the specified vicinity of the unit of equipment;
wherein the update to the impairment status of the unit of equipment is further based on the time the service personnel was in the specified vicinity of the unit of equipment.
